(19) United States
(12) Patent Application Publication
(10) Pub. No.: US 2005/0022238 A1
(43) Pub. Date: Jan. 27, 2005

(54) Device, system and method for programming events

(76) Inventors: Liliana Ardissono, Torino (IT); Fabio Bellifemine, Torino (IT); Alessandro Chiarotto, Torino (IT); Angelo Difino, Torino (IT); Barbara Negro, Torino (IT); Flavio Portis, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/492,279

(22) PCT Filed: Oct. 8, 2002
(86) PCT No.: PCT/EP02/11247

(30) Foreign Application Priority Data
Oct. 10, 2001 (IT) TO2001A000959

(51) Int. Cl. G06F 3/00; G06F 13/00; H04N 5/445

(52) U.S. Cl. 725/45; 725/44

(57) ABSTRACT

The present invention relates to a device (11), system (10) and method for programming and reproducing events, for instance television events, wherein the device (11) is able to prearrange, based on a list of events accessible by a user and of demands expressed by the same user, a programming guide, corresponding to the expressed demands. The device (11) implements one or more modules, representative of one or more Expert modules and/or of one or more parameter class generators, and is able to combine both the Expert modules and the parameter classes to prearrange the programming guide of the events. Thanks to the capability of using multiple Experts and/or multiple parameter classes, the device (11) allows to obtain, in flexible fashion, event programming results that are particularly close to the user's demands.

### TECHNICAL FIELD

The present invention relates to a device and system for programming events and to the method therefor.

In particular, the present invention relates to a device for generating automatic guides for viewing television programmes and to the related method for guiding the selection and viewing of such programmes.

### BACKGROUND ART

As is well known, the widespread use of communications enables to make accessible in various locations and to various users a plurality of events, for example television, radio, multimedia events, which are generally simultaneous, so that it becomes ever more important to make available, to individual users or to groups of users, automatic tools that allow, for a given list of events, their broadcasting times and their duration, to select and personalise (programme) a list of those that are of greater interest to the user.

The programming of television events is taken as an example herein, although, naturally, the considerations that follow are applicable to the programming or personalisation of any type of event whose broadcasting or presentation time can be known in advance and whereof, therefore, it is possible to obtain on the basis, for instance, of the characteristics of individual users or of groups of users, a programming that is suited to the demands of the same users. For instance, in regard to the television industry, automated tools are known, called Electronic Programming Guides or EPG, which are able to guide a given television user or homogeneous group of users in choosing TV programmes (events) to be viewed.

In accordance with the prior art, such tools differ from each other according to the manner or criterion, inherent to the EPG tools, whereby is generated a table or parameter class able to determine the programming of those events which, within the scope of accessible parameters, correspond with a given user's expectations.

A first problem of the prior art consists of the fact that known EPG tools use a single mode, in general constituted by a software module called “Expert module”, to generate a parameter class called “predictions” to be used to select the events to propose to the user and, therefore, they are constrained by the limitations inherent to the use of a single Expert module.

For example, taking as a reference three of the most widely used Expert modules, respectively the Explicit Preferences Expert, the Dynamic Expert and the Stereo-Typical Preferences Expert modules, it is noted that the use of a single Expert module to achieve the programming or personalisation of the events yields endemically lacking programming results.

EPG tools that use the Explicit Preferences Expert (Explicit Expert) module which, as is well known, allows to generate the “predictions” class based on indications explicitly expressed by the user tend to provide programming with poor precision because they are misled by preferences expressed for events that do not correspond with those in which the user is actually interested.

Although EPG tools, that use the Dynamic Expert module (Dynamic or Implicit Expert) which, as is well known, allows to generate the “predictions” class based on the user's previous choices, do provide more precise programming, they tend always to propose the same events over time and hence are particularly inflexible against variations.

Lastly, EPG tools that use the Stereo-Typical Preferences Expert module (Stereo-Typical Expert) which, as is well known, uses stereotypes or categories based, for instance, on the user's age, gender, etc. to identify the “predictions” class to be used in selecting the events to be proposed, tend to provide programming with poor precision, because real users hardly ever perfectly fall within a stereo-typical category.

Therefore, because of the use of a single Expert module, known EPG tools are generally either inaccurate or inflexible against change.

A second problem of the prior art consists of the fact that the various types of known Expert modules are implemented in such a way as to generate only the “predictions” parameter class, so only this parameter class affects the programming of the events of interest for the user.

This problem severely limits the performance and characteristics of the prior art and generally entails a programming that lacks precision.

Use of a module that generates a single parameter class and does not take into account correction or adjustment parameter classes, for instance obtained from a comparison with actual programming choices made by the user or with empirically determined general parameters, severely limits the possible performance of the EPG tool making it inaccurate, poorly reliable and inflexible to change, as will be readily apparent to the person versed in the art on the basis of the invention as described hereinafter.

### DISCLOSURE OF THE INVENTION

The aim of the present invention is a device, a system and method that allows to overcome the limitations and problems of the prior art, in particular constituted by the fact that known EPG tools are able to manage a single type of Expert and a single parameter class.

The aim is reached by the device and system for programming events and by the method therefor, as claimed.

Moreover, the aim is reached by the computer product able to be loaded into the internal memory of an electronic computer as claimed.

In particular, the aim is reached by the device for programming events in which EPG programming tools are able to generate, in addition to the “predictions” class, at least a second parameter class to be associated to the “predictions” class in such a way as to affect the programming of the events on the basis of at least a pair of parameter classes.

### BRIEF DESCRIPTION OF DRAWINGS

This and other characteristics of the present invention shall become more readily apparent from the description that follows of a preferred embodiment, provided purely by way of non limiting example with the aid of the accompanying drawings, in which:

FIG. 1 shows a system and device for programming events according to the invention; and

FIG. 2 shows a flowchart of the method for programming events, according to the invention.

### BEST MODE FOR CARRYING OUT THE INVENTION

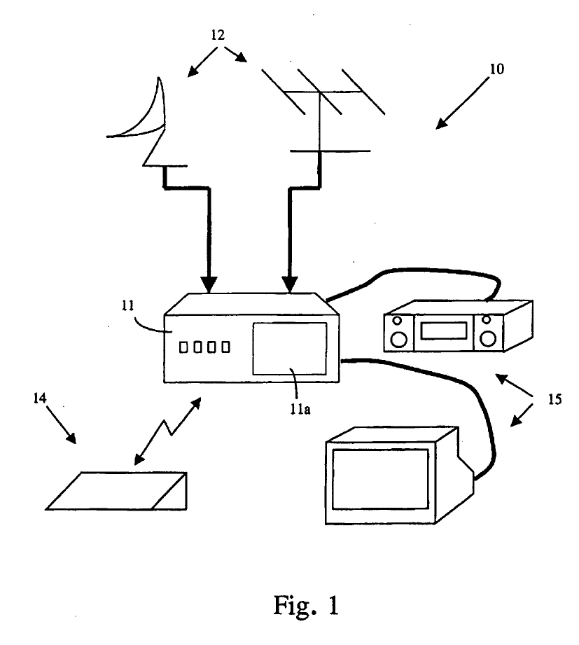

With reference to FIG. 1, a system 10 for programming events comprises a programming device (EPG device or device) 11, one or more antennas 12 to retrieve information about events that are accessible or viewable by a user, a data input and command unit (keyboard) 14 for commanding and controlling the EPG device 11, and one or more apparatuses for reproducing events (apparatuses) 15.

The antennas 12, known in themselves, are connected, in known fashion, to the EPG device 11 by means of interface units of known type and are associated to units able to transfer to the EPG device 11 information abort the accessible events, for instance a list of daily or weekly events on various television channels and/or on radio channels and/or on multimedia channels.

The term “antenna” 12 as used herein has a broad meaning and it also includes devices for connecting, for instance, to local area networks and/or to Internet types of networks and able to retrieve information about events accessible by the user.

The keyboard 14, known in itself, is connected, in known fashion, by means of a corresponding interface unit to the EPG device 11 to activate, for instance, event programming functions and/or data loading functions for executing the method according to the invention and/or programming appreciation functions, as shall be described in detail hereafter.

In particular, through the keyboard 14 the user can provide, upon requesting a programming, indications such as:
settings of time bands to determine event programming;
setting categories of desired programmes;
   and, after a programming operation:
positive or negative appreciation of the suggested programming.

The apparatuses 15, known in themselves, are connected, in known fashion, by means of corresponding interface units to the EPG device 11 and are constituted, for instance, by television sets, by HiFi equipment, by multimedia apparatuses and are able to reproduce, for instance, sounds and/or images based, for instance, on the event programming made by the EPG device 11, as shall be described in detail hereafter.

The EPG device 11 is constituted at the hardware level by a known device, for instance by a personal computer (PC) or by a device known as Set-Top-Box (STB), and comprises at least a memory unit to store data and programmes and, optionally, a display unit (display) 11a to display, for example, user guidance information or information about event programming, as shall be described in detail hereafter.

The EPG device 11 is able to receive, by means of the antennas 12, information regarding future events accessible by the user and is able to process such information on the basis of predefined processing modules and to display on the apparatus 15 and/or on the display 11a the programming operations made, as shall be described in detail hereafter.

The EPG device 11 is also able, as shall be described in detail hereafter, both to interact with the user by means of the keyboard 14, and to manage the apparatuses 15 in such a way that they reproduce the events according to the programming made, as well as to store reference information in the internal memory unit, as shall be described in detail hereafter.

The system 10 in the described configuration is therefore able to allow event programming on the basis of information coming from the antenna 12, on the basis of indications provided by the user with the keyboard 14 and on the basis of processing modules implemented on the EPG device 11.

Naturally, the processing modules, as is readily apparent to those versed in the art, may be constituted by computer modules residing in the memory unit of the EPG device 11 or by computer modules stored on a known support and able to be loaded on each occasion on the EPG device 11.

The method for programming events, according to the present invention, comprises the following steps.

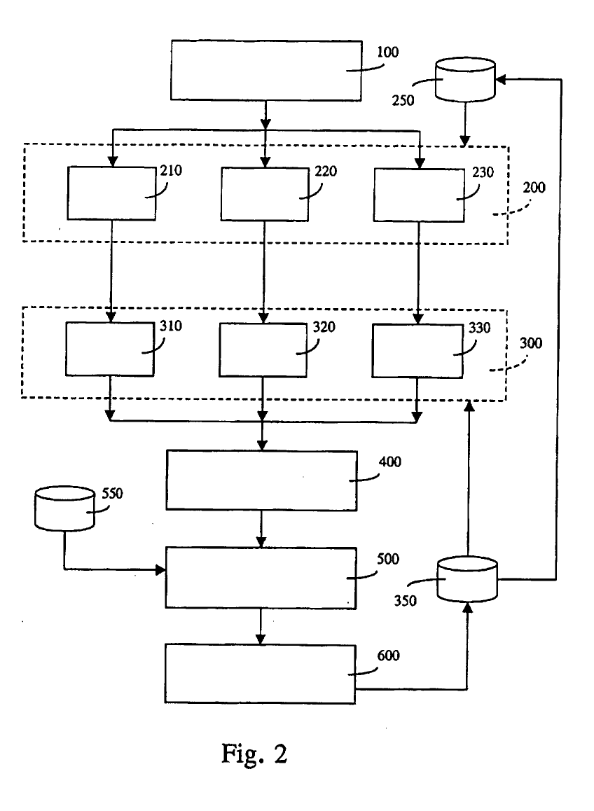

A first step, Prediction Request step 100 (FIG. 1, FIG. 2) in which the user, through the keyboard 14, activates a request to the EPG device 11 for the generation of an event programming that matches the user's characteristics and/or demands.

In this first step 100, the present embodiment provides for the presence on the EPG device 11 of a corresponding user interface module able both to display on the apparatus 15 and/or on the display 11a requests for information to the user and to manage the entered information.

This type of user interface module, known in itself, is able, for instance, to request and manage:
access keys;
period(s) for which the user requires programming;
limiting parameters; for instance, whether the user desires events broadcast by free and/or pay TV channels.

A second step, Expert Execution step 200, in which, on the basis of indications about the user or provided by the user, a first group or set of parameters is generated, as described in detail hereafter.

Said second step 200, considered a possible characteristic element of the present invention, is implemented on the EPG device 11, in accordance with the present embodiment, by means of three Expert modules, each able to generate a pair of parameter classes, respectively:
a “predictions” class: class of parameters that indicate suggestions provided by the Expert module to the user, according to known modes;
a “confidence” class: class of parameters able to assign a reliability value to the “predictions” from the viewpoint of the Expert module.

The “confidence” parameter class, which is considered new, can be obtained either on the basis of empirically determined criteria or on the basis of information linked to the comparison between even programming operations made by the EPG device 11 and actual programming operations made by the user.

In particular, the Expert Execution step 200 comprises an Explicit Expert execution step 210, a Dynamic Expert execution step 220 and a Stereo-typical Expert execution step 230.

The Explicit Expert execution step 210 is able to generate, based on known information, explicitly expressed by the user and stored for example in a first reference memory (User Data Base or DB) 250, a table of values, an example whereof is shown in Tab.1.

As apparent to a person versed on the art, the information stored into the DB 250 can be organised in any useful format, as, for example, a specific format or a standard format, like the MPEG-7.

TABLE 1

| Category | Prediction | Confidence |
|---|---|---|
| Sport-Football | 70% | 90% |
| Sport-Basketball | 65% | 20% |
| Films-Science Fiction | 5% | 70% |
| . | . | . |
| . | . | . |
| . | . | . |

In particular, “Prediction” values are obtained by the Explicit Expert in known fashion, as described in the literature.

“Confidence” values are obtained, for instance, as a function of quantity and precision of explicit information indicated by the user.

For instance, the “confidence” value of the Explicit Expert for the “Sport-Football” category of Tab.1 takes on a higher value if the user has explicitly indicated that (s)he prefers “Sport-Football” events and a lower value if the explicit indication was directed not to the “Sport-Football” category but to a more general category, for instance “Sport”.

The Dynamic Expert step 220 is able to generate, based for example on information about the user's previous choices, stored in the User DB 250, a second table of values, equivalent in the form to the one shown in Tab.1, but containing, for equal categories, “prediction” and “confidence” values as calculated by the Dynamic Expert.

In this case too, “prediction” values are obtained by the Dynamic Expert in known fashion, as described in the literature.

“Confidence” values are obtained for example using an experience measure based on the quantity of data already managed in equivalent conditions.

In particular, “confidence” is determined, given a minimum learning phase, by means of a function, for example of linear type, based on the number of cases observed or managed in the past for a specific type of context (for example, days of the week, time bands, etc.).

The Stereo-typical Expert execution step 230 is able to generate, based on known information explicitly expressed by the user stored in the User DB 250 and able to determine a reference stereotype, a third table of values, equivalent in form to the one shown in Tab. 1, but containing, for equal categories, “predictions” and “confidence” values as computed by the Stereo-typical Expert.

In this case, too, “prediction” values are obtained by the Stereo-typical Expert in known fashion, as described in the literature.

“Confidence” values are obtained, for instance, by means of an algorithm of the type set out below:
confₛ=1−Δₛ/Δₘₐₓ 1]
wherein Δₛ=Matchₘₐₓ−Matchₘᵢₙ in which:
confₛ indicates the confidence value for each category of Tab.1;
Matchₘₐₓ and Matchₘᵢₙ respectively indicate the degree of correspondence or maximum and minimum match of the specific user with respect to the stereotypes; and
Δₘₐₓ the maximum value among all Δₛ.

The Expert Execution step 200 is followed, additional possible characteristic element of the present invention, by a Reputation Association step 300 in which the value classes generated by each Expert module are completed with a third parameter class, herein called “reputations” class.

The Reputation Association step 300 is implemented on the EPG device 11, in accordance with the present embodiment, by means of three modules, each able to generate (steps 310, 320 and 330) a “reputations” class to be associated to the values generated by the corresponding Expert modules in the steps 210, 220, 230, based on a comparison between the “predictions” class executed by the respective Expert module in the steps 210, 220 and 230 and the actual programming made by the user, stored, for instance, in a second reference memory (Programming DB) 350, as shall be described in detail hereafter.

In particular, for each Expert module the corresponding “reputations” class is calculated, for instance, comparing the “predictions” generated by a determined Expert with the user's actual actions. Said comparison allows to increase or decrease the “reputation” values of the same Expert.

For instance, if for a “prediction” of an event by a determined Expert module, it is found, as shall be described in detail hereafter, that the user, alternatively:
has watched or selected the programme,
has not watched the programme,
has expressed a negative opinion about the programme, the “reputation” will correspondingly be attributed to the Expert module in decreasing fashion on the basis of the aforesaid alternative options.

The Reputation Association step 300 is followed, other possible characteristic element of the present invention, by an Expert Combination step 400, in which, based on the different parameter class or value tables generated by the Expert modules in the pairs of steps 210 and 310, 220 and 320, 230 and 330, a single parameter class is generated, herein called “combined predictions” class.

The Expert Combination step 400 is implemented on the EPG device 11, in accordance with the present embodiment, by means of a corresponding module able to generate, on the basis of the values generated in the steps 200 and 300, a “combined predictions” table, for example of the type shown below in Tab.2.

TABLE 2

| Category | Combined Prediction |
|---|---|
| Sport-Football | 75% |
| Sport-Basketball | 50% |
| Film-Science Fiction | 10% |
| . | . |
| . | . |
| . | . |

In particular, the module for the execution of the Expert Combination step 400, called, in accordance with the present embodiment, UMC (User Modelling Component) module, is able to compose the three-value sets (“predictions”, “confidence”, “reputations”), for instance by means of a mathematical formula of the normalised weighted average type, as shown below;

$${P}_{i} = \frac{{\sum }_{e = 1}^{3} ( {c}_{e , i} * {P}_{e , i} ) * {r}_{e}}{{\sum }_{e = 1}^{3} {c}_{e , i}} \qquad 2 ]$$

in which:
Pᵢ indicates a prediction for the i-th category (e.g. sport-football);
P_{e,i} indicates a prediction for the i-th category (e.g. sport-football) by the e-th Expert (e.g. Stereo-typical Expert);
C_{e,i} indicates a confidence level of the e-th Expert for the prediction on the i-th category; and
rₑ indicates a reputation of the e-th Expert.

After completing in sequence the Expert Execution step 200, the Reputation Association step 300 and the Expert Combination step 400, considered possible characteristic elements of the present invention, in accordance with the present embodiment, an actual event programming step (Event Programming) 500 is activated.

The Event Programming step 500 is a phase in which, based on the values of the “combined predictions” class and of the list of accessible events, for instance stored on a third reference memory (Events DB) 550, known in itself, a guide or programming guide is generated, for instance of TV programmes, containing only indications pertaining to the events considered, in accordance with the described method, to be of interest for the user.

The Event Programming step 500 is implemented on the EPG device 11 by means of a corresponding module, known in itself, able both to associate the values of the “combined predictions” class to the list of events stored in the Events DB 550, and to display, for instance, on the display 11a a list of programmes (suggested programming or programming guide) personalised for the determined user or group of users who had activated the method by means of the Predictions Request step 100.

In said step 500 the user, given the suggested programming guide, can perform different actions, known in themselves, such as:
selecting specific events within the suggested list;
expressing positive or negative opinions for determined events in the list.

Naturally, said Events Programming step 500 can also comprise modules able to request indications from the user to make the suggested programming operational, for instance by means of menus, timed indications, etc.

The method according to the present invention further comprises a step of storing the events programmed by the Expert modules and the events actually programmed by the user (Programming Storage step) 600, which also is considered a possible characteristic element of the present invention.

The Programming Storage step 600 is implemented, for instance, by means of a corresponding storage module, known in itself, able to store in the Programming DB 350 of the EPG device 11, daily and/or with a periodicity corresponding to the user's prediction requests, both the programming suggested in the Events Programming step 500, and the programming actually employed by the user,

The information stored in the programming DB 350, as will be readily apparent to those versed in the art, can thus be used in the Reputation Association step 300 to generate the “reputations” class to be associated to the results generated by the corresponding Expert modules in the Expert Execution step 200.

The information stored in the programming DB 350 are also used to update the User DB 250 in such a way as to be utilised, for instance, by the Dynamic Expert.

The flow of operations for the automatic programming of events, in accordance with the present invention, is, based on the above description, as follows.

Following the user's request to activate a programming, the EPG device 11 activates the Predictions Request step 100 which, after a phase of verifying the user's characteristics (User Name, password) and any additional information about the time band or period for which the user desires programming, activates in sequence the Expert Execution step 200, the Reputation Association step 300, the Expert Combination step 400 and the Events Programming step 500. Said steps operate in sequence and automatically, and allow to generate suggestions about television programmes of greater interest for the user.

In particular, the Predictions Request step 100 allows to activate in parallel all available experts, for instance the Explicit Expert module and the corresponding step 210, the Dynamic Expert module and the corresponding step 220 and the Stereo-typical Expert module and the corresponding step 230. Each of said expert modules draws data from the User DB 250, by specifically drawing data from the user profile information, and generates a pair of value classes (“predictions”, “confidence”).

In sequence, by means of the steps: Explicit Expert Reputation association 310, Dynamic Expert Reputation association 320 and Stereo-typical Expert Reputation association 330, to each of the value class pairs is associated a new value class (“reputations”), with the consequence that at the end of the step 300 is generated a number of sets of three value classes (“predictions”, “confidence”, “reputations”) equal to the number of available Expert modules.

In the subsequent Expert Combination step 400, starting from the sets of three value classes, a single “combined prediction” class is generated and, on the basis thereof, in the subsequent Event Programming step 500, the programming suggested to the user is generated and shown as a programming guide on the display 11a or on the apparatus 15, if it is a television set or apparatus fitted with a display.

The flow of the activities, in accordance with the present method, is completed by the Programming Storage step 600 whereby the user's programming choices (what (s)he has seen, for how long (s)he has seen it, his/her opinion of the suggestions provided by the application) are stored in the Programming DB 350 to be made available, in particular, to the modules able to implement the Reputation Association step 300 of the available Expert modules.

In accordance with the present invention, the information contained in the Programming DB 350 are to be used to increase or decrease the “reputations” class of each individual Expert available.

The device for programming events, the system and the method therefore have been described heretofore taking as reference three parameter classes, whereof one is constituted by a “predictions” class and the others by classes whose values are determined on the basis of data correlated to the same Expert module used, either because they were obtained on the basis of empirical evaluations or because they are linked to historical information.

Naturally, the system, the device and the method described herein are also applicable using only two parameter classes, for instance the “predictions” and “confidence” class or the “predictions” and “reputations” class, without thereby compromising one of the possible characteristics of the invention which, as will be readily apparent to those versed in the art, are linked to the use of parameters able to correct the inherent limitations connected with the use of the “predictions” class alone.

The device for programming events, the system and the method therefore have been described heretofore taking as reference the use of three Expert modules in parallel but, as will be readily apparent to those versed in the art, the device, the system and method according to the invention retain their innovative characteristics even using a single Expert module or a number of Expert modules higher than the ones described herein.

The device for programming events, the system and the method therefore have been described heretofore taking as reference the programming of television events but, as will be readily apparent to those versed in the art, the device, the system and the method are usable also for all types of events whose accessibility and duration is known in advance and/or is considered useful for the users, as, for example, E-Shop events, News etc.

Obvious modifications or variations are possible to the above description, in dimensions, shapes, materials, components, circuit elements, connections and contacts, as well as in the details of the circuitry and of the construction illustrated herein and of the operating method without thereby departing from the spirit of the invention as specified in the claims that follow.

1. Device for programming events comprising
a first interface unit connectable to an information input unit (12) for receiving information about a plurality of alternatively programmable events;
a second interface unit connectable to an events reproduction apparatus (15) able to reproduce said events on the basis of a programming guide of said events;
characterised by
a first and at least a second parameter generator; and
programming modules able to prearrange the programming guide of said events on the basis of parameters generated by said first and at least a second parameter generator.

2. Device as claimed in claim 1 characterised in that
said first parameter generator is able to generate a first parameter class indicative of “predictions” values; and
said at least a second parameter generator is able to generate a second parameter class indicative of corrective values of said first parameter class.

3. Device as claimed in claim 2, characterised in that said second parameter class comprises “confidence” parameters representative of reliability values to be attributed to said first parameter class.

4. Device as claimed in claim 3, characterised by
a third interface unit connectable to a command input unit (14) able to generate an actual programming of said events on the basis of said plurality of alternatively programmable events; and by
a third parameter generator able to generate a third parameter class comprising “reputations” parameters, representative of values of comparison between said programming guide and said actual programming.

5. Device as claimed in claim 2, characterised by
a third interface unit connectable to a command input unit (14) able to generate an actual programming of said events on the basis of said plurality of alternatively programmable events; and in that
said second parameter class comprises “reputations” parameters, representative of values of comparison between said programming guide and said actual programming.

6. Device as claimed in claim 1 characterised in that
said first parameter generator is able to generate first “predictions” values on the basis of first reference values;
in that
said at least a second parameter generator is able to generate second “predictions” values on the basis of second reference values; and by
a “predictions” combination module able to combine said first and second “predictions” values and to generate said parameters for said programming modules.

7. Device as claimed in claim 6 characterised in that
said first parameter generator comprises an Expert module of the explicit type or of the dynamic type; and in that
said at least a second parameter generator comprises an Expert module of the dynamic type or of the stereo-typical type.

8. Device as claimed in claim 6 characterised by
a third parameter generator able to generate third “predictions” values on the basis of third reference values.

9. Device as claimed in claim 8, characterised in that
said first parameter generator comprises an Expert module of the explicit type;
said second parameter generator comprises an Expert module of the dynamic type; and
said third generator comprises an Expert module of the stereo-typical type.

10. System for programming events comprising
an information input unit (12) for receiving information about a plurality of alternatively programmable events;
an events reproduction apparatus (15) for reproducing said events on the basis of a programming guide of said events; characterised by a
a device (11) connected to said information input unit (12) and to said events reproduction apparatus (15) and configured according to claims 1 to 9.

11. Method for programming events characterised by the steps of
activating, on the basis of a plurality of alternatively programmable events, a programming guide of said events by means of a programming device (11);
generating a first and at least a second parameter set; and
prearranging the programming guide of said events on the basis of said first and at least a second parameter sets.

12. Method as claimed in claim 11, wherein the step of generating a first and at least a second parameter set comprises the steps of
generating a first parameter class, indicative of “predictions” values; and
generating a second parameter class, indicative of corrective values of said first parameter set.

13. Method as claimed in claim 11 characterised by the additional step of
generating an actual programming of said events on the basis of said plurality of alternatively programmable events; and
storing said programming guide and said actual programming.

14. Method as claimed in claim 13 characterised in that said step of generating said second parameter class comprises the step of
comparing said programming guide and said actual programming.

15. Method as claimed in claim 11, wherein the step of generating a first and at least a second parameter set comprises the steps of
generating first “predictions” values on the basis of first reference values; and
generating at least second “predictions” values on the basis of second reference values; and
prearranging the programming guide of said events by combining said first “predictions” values and said at least second predictions values.

16. Computer product able to be directly loaded into the internal memory of an electronic computer and comprising portions of software codes to implement the method as claimed in any of the claims 11 through 15 when the product is run on an electronic computer.
